(19) United States
(12) Patent Application Publication
(10) Pub. No.: US 2005/0237736 A1
(43) Pub. Date: Oct. 27, 2005

(54) Combined light and whistle keychain holder

(76) Inventor: Joseph P. Wimsatt, St. Louis, MO (US)

Correspondence Address: Paul M. Denk, 763 S. New Ballas Road, St. Louis, MO, 63141, US

(21) Appl. No.: 11/109,516

(22) Filed: Apr. 19, 2005

Related U.S. Application Data
(60) Provisional application No. 60/565,024, filed on Apr. 23, 2004.

(51) Int. Cl. F21V 33/00

(52) U.S. Cl. 362/196; 362/109; 362/116; 362/200

(57) ABSTRACT

A combined light and whistle keychain holder incorporating molded components that form upper and lower halves for the housing, a light LED is provided forwardly of the holder, extending through its frontal surface, so as to furnish illumination when switched on. The light can either be switched on permanently, or simply held on by depressing the switch, for temporary usage. The back of the holder incorporates a whistle, shaped and formed from the two holder upper and lower half components, such that when blown, emits a high pitched loud warning sound, to anybody in the immediate vicinity. Integral loops are provided laterally of the holder, so that one or more of a collection of keys, may be applied hereto, but be readily removable, as required.

### CROSS REFERENCE TO RELATED APPLICATION

This non-provisional patent application claims priority to the provisional patent application having Ser. No. 60/565,024, which was filed on Apr. 23, 2004, and which claims priority to the design patent application having Ser. No. 29/194,501, which was filed on Nov. 25, 2003.

### BACKGROUND OF THE INVENTION

This invention relates to a keychain, and more specifically a unique keychain incorporating a whistle, light, and other accessories that provide for the safety of the user and owner.

Various types of whistles, key chains, and the like, primarily for personal usage, as for example for insertion within a woman's purse, or for holding the keys, or which provides a light for illumination purposes to aid in the insertion of the key into a lock or ignition, have long been available in the art. In addition, a whistle, for safety purposes, has also been available in the art. To combine all of these into a single entity, and to make it compact enough for ease of storage, as in the purse, or pocket, but yet hold all of the keys of the user, is a desirable contribution to the art.

Various type of prior art that are available, and in certain instances previously patented, as can be seen in the prior patent to Bautsch, No. Des. 192098, showing a combined flashlight, whistle, compass, and keychain holder. While this prior art shows many of the combined items as set forth in this current invention, the current invention is structured differently, functions differently, to furnish its own particular results.

The letters patent to Bautsch, U.S. Pat. No. 3,085,150, shows the structural aspects of the flashlight construction as previously reviewed in the earlier Bautsch design patent.

U.S. Pat. No. 4,449,474, to Mariol, shows a personal security device. This device also includes a whistle, a light, all for use for security purposes, and to add to the safety of the owner.

The patent to Collins, U.S. Pat. No. 5,475,368, discloses a keychain alarm and light. This particular device incorporates a speaker that produces an extremely loud alarm signal, when actuated.

The patent to Huang, U.S. Pat. No. 5,826,534, shows a whistle, with a bulb, for functioning as a keychain, but also furnishing illumination, and allowing sound, apparently for security purposes.

Finally, the patent to Chang, U.S. Pat. No. 5,956,989, shows another multi-function key holder, that also incorporates a compass.

### SUMMARY OF THE INVENTION

This invention relates principally to means for facilitating the security and protection of the owner and user, and specifically relates to a compact, fully molded, device that incorporates a whistle, high intensity light, and other means for holding keys, and which can be independently actuated to furnish its defined attributes, but yet is sufficiently small enough to fit conveniently within the purse or pocket.

This device is a multi-use mini-type flashlight that also incorporates an extremely loud safety whistle, and a quick release keychain, furnishing all of these types of beneficial results for the user. A multi-function flashlight, having a high intensity LED, is shown and described herein having three discrete functions, one is to provide a small self contained light, the device also is designed for furnishing a loud safety whistle to frighten away any perceived or real threat to one's security, and thirdly, a keychain with a quick release means and action that makes adding or removing the keys rather quick and facile.

The casing for this multi-functional flashlight has parallel top and bottom components, that are spaced apart vertically, but which when brought together and fastened by screws, or welded electronically or with adhesive, furnishes a rather streamlined and compact housing for the various electrical and other components that make up the instrument as previously described. The light furnished by the flashlight component may be a super bright red or other clear LED bulb, that is disposed at the front of the case, and extends approximately a short distance beyond the front of the case, so as to furnish clear illumination in all directions, at least forwardly of the housing. To actuate the light, a ribbed switch button is generally furnished laterally of the housing, and can be pressed in or shifted forwardly, to connect a power source, or shifted rearwardly, to provide for disconnection, but that when the light is to be illuminated, lithium or other battery provides the conduct of charge to the bulb, for its temporary or continuous “on” mode. Slight pressure exerted on the top of the switch, and a quick withdrawal puts the light in a quick “on-off” mode.

The various components located within the housing, include the circuitry provided for an “off-on” function, through the switch, a battery, and various circuit lines that interconnect the switch, battery and light, to provide for its prompt illumination, when the switch is either forced forwardly, or depressed. The replaceable lithium battery, usually of the newer version that is of a circular design, is a unique feature for this particular mini flashlight. It provides for full illumination, with plenty of lasting charge, but yet takes up very little room within the housing, thereby reducing the size of the housing necessary for furnishing this type of instrumentation. Similarly, the battery can be easily removed and replaced by simply removing a battery cover that is secured by one or more minuscule screws, in order to change out the battery when it becomes necessary. As is well known, though, lithium batteries, of this type, do provide a very lasting charge.

In the rearward portion of the housing for the device, a rear cavity is contained therein, and is uniquely molded into a specific form, so as to provide a chamber for the whistle of the type with or without a ball, which when air is applied to it, furnishes a loud screeching or whistle noise, generally of the type as well known in the art and is used by, for example, various officials in sporting events, when employed.

Therein is provided at the direct back end of the housing, where pressurized air from one's mouth can permit blowing of it into the air chamber, and with an outlet provide at the top, to permit the release of air that was blown into and through the air chamber, thereby permitting the generation of an extremely loud whistling sound, out of the housing, for the safety of the user.

Another feature of the invention is the means to facilitate the attachment of the key chain to the reinforced molded loops that are attached to the outside, generally laterally, segment of the housing sides. The chain may have a quick release, so that the key holder is adapted to hold one or more of the keys thereon and can be quickly released, so that their usage away from the housing can be readily made, when necessary. For example, one's door and other personal keys may be hooked onto a key holder at the front of the device, while the automobile keys may be located on a chain at the back of the housing. Thus, the automobile keys can be quickly released, to separate the automotive keys from the house keys, when that becomes a necessity.

It is, therefore, the principal object of this invention to provide a combined keychain, whistle, light, all embodied and attachable with a molded housing.

Another object of this invention is to provide for a very bright illumination of light from an LED that can light under dark conditions, when necessary, such as for finding the door lock, key ignition entrance, or for other uses for the vehicle, or elsewhere when necessary and employed.

Another object is to provide a very loud whistle for the safety of its user.

Still another object is to provide a very compact housing or encasement, for this type of a holder that may conveniently fit within the pocket, a small purse, or at other locations.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings, FIG. 1 is a perspective view of the combined light and whistle keychain holder of this invention;

FIG. 2 is a top plan view;

FIG. 3 is a bottom view;

FIG. 4 is a left side view;

FIG. 5 is a right side view;

FIG. 6 is a front view;

FIG. 7 is a back view of the invention;

FIG. 8 is a partially exploded view of the top of the holder showing the access cover and a battery extended upwardly therefrom;

FIG. 9 is an interior view of the bottom of the housing;

FIG. 10 is a view of the upper part of the housing showing the battery, switch and light for illumination provided from the device;

FIG. 11 shows the switch initiated for turn on of the light of the holder;

FIG. 12 provides a circuit diagram for the battery, switch, and providing for the lighting aspects of this holder;

FIG. 13 shows an interior top view of the specific shell casing for the upper housing for the invention; and

FIG. 14 shows the interior view of the bottom shell casing for the housing.

### DESCRIPTION OF THE PREFERRED EMBODIMENT

In referring to the drawings, for this application, and in particular FIG. 1, it can be seen that the combined light and whistle keychain holder of this invention, is readily shown at 1. It includes a smooth transitional body, from a backend, as at 2, and upon which one presses the whistle against the lips for blowing into the same, to emit a loud alarming sound, and the housing gradually expands outwardly, along a smooth curvature, as can be noted at 3, to a frontal configuration 4, which houses the lighting components of this invention. As can also be seen, the housing 5 forming this device includes an upper segment 6, and a lower segment 7 conveniently mating together to provide for a smooth closure of the outer surface of the side walls for the holder. A slide or press switch 8 is provided laterally, within one side of housing, and its opening that allows for its disposition at this location, for manipulation by the thumb, is formed from a pair of apertures, generally as at 9, in which this switch locates, and readily available for manipulation in a sliding movement either forwardly, to initiate lighting, or rearwardly, as to shut it off. Or the switch can be pressed in to energize the light. The housing also includes a rear opening, as at 10, upon which one blows, to cause significant vibrations to the ball located therein, with the air being admitted out of the aperture 11, along with the loud sound generated, so as to act as a cautionary and warning device, in the event that an emergency condition exists, for the user.

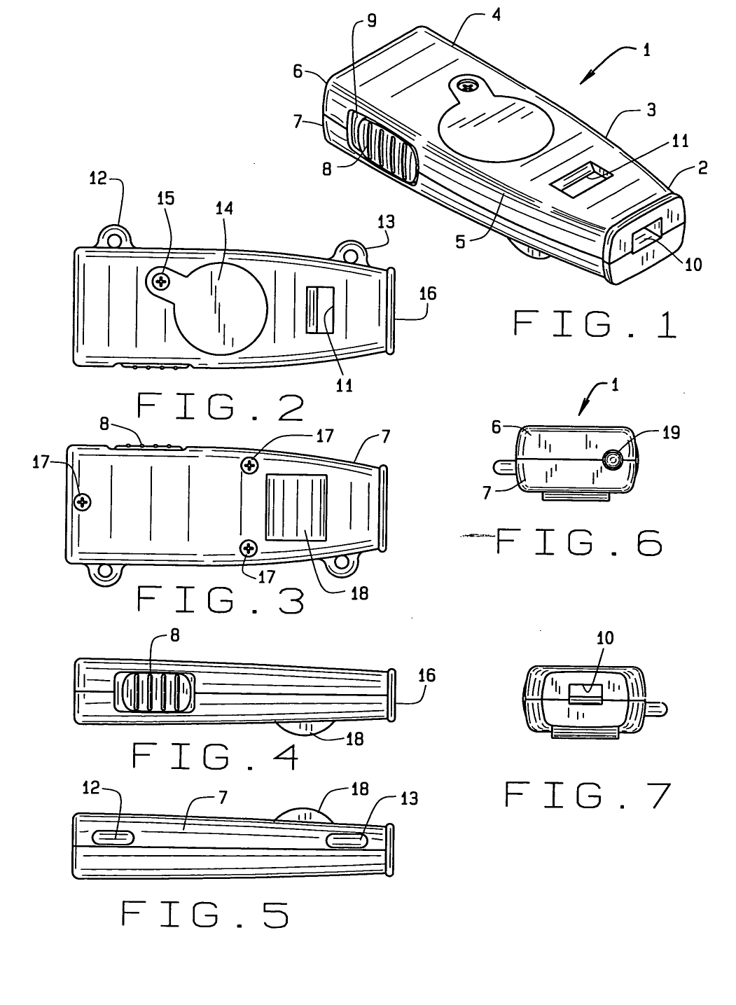

The top view of the holder is shown in FIG. 2, and it can be seen that formed integrally laterally to the sides of the housing 5 are a pair of loops, as at 12 and 13, and to which the key chains may be affixed. For example, as previously reviewed in the summary, the car keys may be located upon a chain which removably connects with the loop 12, but can be removed, when the keys are to be separated therefrom. In addition, for example, the rearward loop 12 may have the house keys interconnected therewith, so as to separate these two sets of keys, for ready accessibility, and independent usage. As can also be seen upon the top view in FIG. 2, a cover 14 is held in position by means of the fastener 15, so as to furnish ready access to a lithium disc style battery, located therein, and to provide for its ready replacement, in the event that the battery dissipates, and becomes discharged. The air outlet, as at the aperture 11, can also be readily seen. In addition, there is a slight lip 16 provided around the back edge of the housing, so as to facilitate the locating of the lips thereat, as when furnishing pressurized blowing into the holder, during application of its whistle component.

FIG. 3 shows a bottom view of the holder. As can be seen, the various threaded means, such as the fasteners 17, hold the two halves of the housing together, when affixed in place. The slide switch 8 can also be noted. In addition, in order to accommodate the usual components of such a whistle, the bottom half of the housing, 7, incorporates an integrally budging area 18, so as to accommodate the standard ball therein, used in such a whistle, and to provide the necessary shape and configuration required to accommodate the integration of such a whistle into the structure of this holder.

FIG. 4 discloses the location of the switch 8 laterally of the housing, as along its left side.

FIG. 5 furnishes a right side view of the holder, and the various loops 12 and 13 and how they are integrated into the structure of the lower half 7 of the housing as readily disclosed.

FIG. 6, which provides a front view of the holder, shows the location of the lamp 19 and the opening that accommodates it, which is disclosed at the front of the housing for this holder 1. The lamp will extend slightly forwardly, through the opening, so as to provide for a general illumination in an approximate 180° degrees semi-spherical direction, to provide full illumination at the region where the lamp is applied, as for example, when lighting the location of an automobile or home door lock, which needs to be illuminated for insertion of a key. It can be seen that the opening, through which the lamp 19 projects, may be molded into each half 6 and 7 of the shown holder. Or, it is just as likely that the lamp could extend through a single formed aperture, through the end walls of one of the halves, as can be understood.

FIG. 7 shows the back end of the holder, and its opening 10 through which one blows when energizing the whistle, as the need arises.

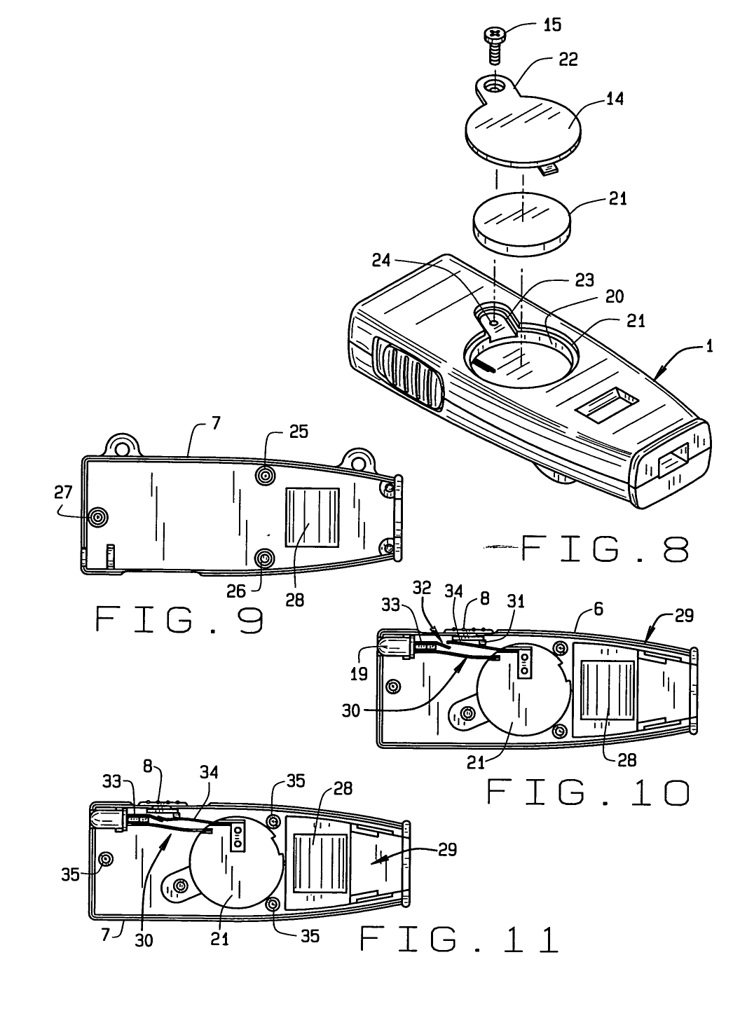

FIG. 8 shows a slightly exploded view for the holder 1. In this instance, the opening 20 through which the battery 21, which may comprise a lithium disc battery, as can be understood, locates, when inserted within the device, and to provide for energization for its lighting. The cover 14, and its threaded fastener 15, are readily disclosed, and insert upon the shoulder area 21 for the holder, and the cover incorporates an integral extension 22, that inserts within the elongated slot 23 of the top wall of the holder, in order to accommodate the insertion of the fastener 15, within the threaded opening 24, when the battery has been located.

FIG. 9 shows an interior view of the bottom half 7 for the device. It shows the arrangement of the threaded stems 25 through 27, into which the fastener 17 locate, when securing the two halves of the holder together. Or the two halves of the holder can be sonic welded or adhesively connected together. The bottom portion of the whistle, as at 28, and its integral molding therein, can be seen.

FIG. 10 shows an interior view of the upper housing segment 6, and the various other components that form the whistle, as at 29, in addition to the forwardly disposed electrical circuitry that illuminates the lamp 19 during usage. The switch mechanisms for illuminating the lamp, or turning it off, are also shown at 30. The switch acts in conjunction with the thumb switch 8, which incorporates a depending tab 31 which, when the switch 8 is arranged therein rearwardly within the holder, provides for an opening or deenergization in the leaf switch, as can be noted at 32, so as to deenergize the lamp. Hence, the leg that holds the lamp, as at 33, extends rearwardly, and is disposed for contact by the spring switch 34 when the switch tab 31 is moved forwardly, and depresses the switch 34 downwardly to make contact with the circuit contact 33. This means for providing electrical contact therein can be noted in FIG. 11, where the switch 8 has been moved forwardly, and maintains electrical contact therethrough, to illuminate the lamp from the battery 21. The various contacts between the battery, and its circuit lines formed into the switch, can be seen as at 30. Also, simply pressing the switch inwardly can also temporarily illuminate the lamp.

The apertures 35 through which the fasteners 17 locate can also be seen in FIG. 11. In addition, the shaped configuration of the inlet, as at 28, which forms the whistle component for the holder, is also disclosed. Hence, when the upper half of the holder 6, as shown in FIG. 10, is arranged over and mated with the lower half 7, as shown in FIG. 11, and the threaded fasteners 17 are engaged, the entire whistle component is formed, for accommodating a blowing when necessary to emit a loud sound, as required. Obviously, one of the balls (not shown) that locate within the portion 28 for the whistle will have previously been provided therein, before the holder is formed and closed into its usable configuration.

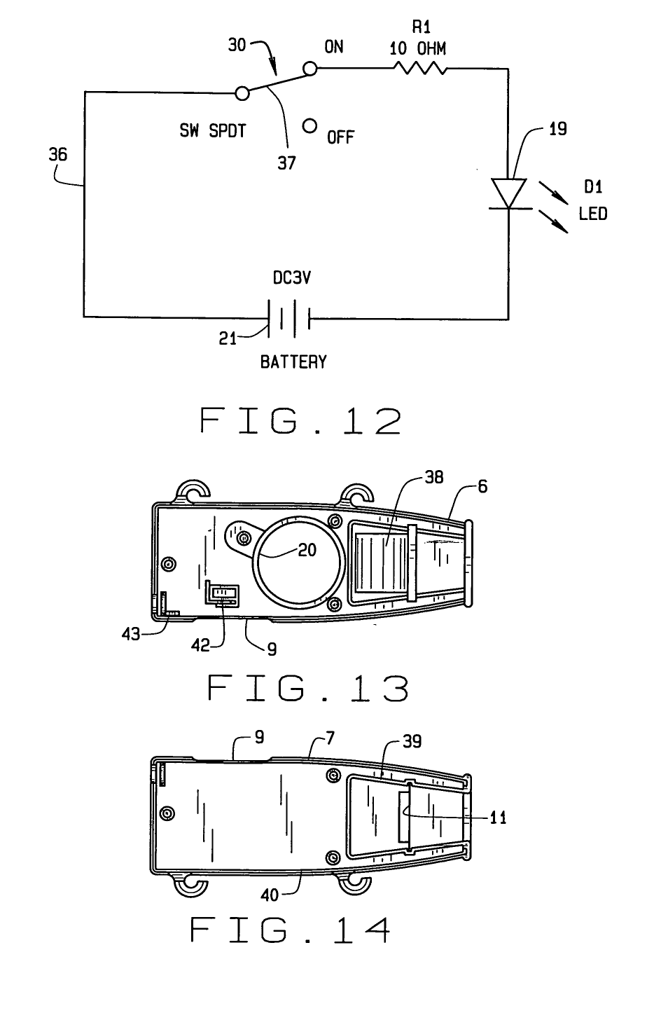

FIG. 12 shows a circuit diagram for the lighting component. As can be noted, the “off-on” switch, such as manipulated by the thumb switch 8, is generally shown at 30. The circuit line leading from the switch or at least the back of the lamp, and which extends to the battery, can be seen at 36. The battery 21 is generally disclosed in the circuit arrangement. The light, or the LED, that provides for illumination, when the switch is turned on, as shown in the circuit diagram, can be seen at 19. Obviously, when the thumb switch 8 is shifted rearwardly, then the circuit component 37 provides for disengagement between the switch elements 33 and 34, shifting the circuitry to the off position.

FIG. 13 shows the interior view of the shell casing for the upper housing, as at 6, which shows the battery cover aperture 20, as can be seen. More specifically, the ribbed walls that form the whistle, at the rearward part of the housing, can be seen at 38, and this particular system of walls, as can be noted, is designed for intermating and sealing with a similar type of ribbed wall, as at 39, provided in the bottom segment 7 of the lower housing, as can be noted. The whistle opening 11, which allows the air to exit the whistle, during usage, can be noted. In addition, the various openings, as at 9, that are formed in both the upper and lower segments of the housing, and which accommodate the location of the sliding off-on switch therein, can be seen. Furthermore, the mating relationship between the upper and lower segments of the housing, 6 and 7, and which incorporate their ribbed components, as at 40 and 41, can be seen, so as to provide for a very tight and snug interconnection of these two components of the housing together, when assembled.

Also, as can be seen in FIGS. 13 and 14, loops 12 and 13 that are formed laterally of the holder each be fabricated of open sections, as can be seen in these figures, such that when the two halves of the holder are brought together, they form a complete closure for holding any key ring or the like.

Furthermore, the structure integrally formed within the upper segment of the housing, such structures as shown at 42, 43, and related type structure, is readily disclosed for holding the electronics, and the lamp, in a position forwardly of the structure of the whistle, and which co-act with the battery 21, in order to illuminate the lamp 19, through usage of the structure, and the circuitry, as previously described with respect to the embodiments in FIGS. 10-12 of this described invention.

The holder of this invention, which incorporates conventional flashlight components, may come in various sizes and shapes, but in this particular instance, is designed for furnishing a simple LED lamp, within the holder, so as to provide a minimum of structural components. Other flashlights require many other components, such as hollow tubes, bulbs, reflectors, lenses, and screw on tops, for their assembly. This particular invention provides for minuscule assembly of a minor number of components so that the device and holder can be carried on the person, throughout the day, without any annoyance. The recent developments of miniature LED bulbs, and the lithium battery, allows for substantial reduction in the size of the lighting components that can integrated into the holder of this invention.

This particular invention incorporates not only the lighting components, but the safety whistle component used in combination with a key chain, which is small, compact, and durable. It easily fits within the hand of the user, or can comfortably be carried in the pocket, purse, or backpack. In addition, it provides instant light, and extremely loud safety whistle, and a premium keychain, or a plurality of them, one or both with quick release features.

The LED bulb used in this invention is a 5 mm super bright red that can generally be seen over a half mile in distance, if that type of warning is necessary. It is very useful in emergency conditions. The life of the bulb, for this assembly, is in the ten thousand hour range. The lithium disc battery is replaceable, meaning that this holder can be used indefinitely, once obtained. The switch itself has two functions, it can be used as a press on type of switch, such as when the switch is depressed within the holder, and it makes electrical contact for illuminating the bulb. Or, it can be shifted forwardly, to provide for a continuous “on” mode for the lamp. It is believed that this feature is unique within a mini flashlight, of this design.

The molded structure for the holder of this invention may be fabricated into various bright colors, to add to their pleasing aesthetics.

In addition to the forgoing, it is possible that the lower part of the housing holder could incorporate a resilient clip, so that this light could be clipped onto the bill of a cap, or other structure, to allow for hands free work, to allow the user to perform other work, while yet having illumination in this manner.

The safety whistle has a unique design with a separate molded belly, as the component 28, that allows for an extremely high decibel emission of sound. The device, or its holder, can be ABS molded plastic, to give it many years of maintenance-free service. The keychain may be fabricated from any high quality plated metal, with strong connecting wire rings, and it may incorporate any of the quick release devices that allow for removal of the key or keys, facilely, and promptly.

Variations or modifications to the subject matter of this invention may occur to those skilled in the art upon review of the invention as disclosed herein. Such variations if within spirit of this invention are intended to be encompassed within the claims to invention as set forth in this application. The description of the preferred embodiment and depiction of the various components for this holder as shown in the drawings, are set forth for illustrative purposes only.

1. The combined light and whistle keychain holder, said holder being formed of two halves, an upper half and a lower half, said upper and lower halves being mattingly connectable together, a whistle made audible through pressurized air molded and located within the rearward segment of the holder, an illuminatably LED light provided in the forward segment of the holder, a switch provided laterally of the housing, and capable of temporarily or permanently completing circuitry to illuminate the light, or shifted rearwardly or released to provide for turn off of the light, and at least one loop integrally formed laterally of the housing to accommodate the attachment of a keychain.

2. The holder of claim 1 wherein the upper and lower halves mate together and are secured by fasteners to integrate the upper and lower halves into the assembled holder.

3. The holder of claim 2 wherein the whistle comprises a ball type whistle, the rear of the housing in both its holders having a shape to accommodate the contiguous locating of the lips of the user to blow into the housing to emit a whistle sound for warning purposes.

4. The holder of claim 2 and including switch circuitry provided within the holder, a support for holding a disc battery therein, the switch circuitry engagable with the battery, and the lamp, through the switch, to provide for illumination of the lamp when the switch is engaged, and to provide for turn off of the lamp when the switch is disengaged.

5. The holder of claim 4 and including a cover connectable with one of the upper and lower halves of the holder, an aperture provided within the upper and lower half to accommodate the battery therein, and a shoulder formed to provide for seating for the cover when securing the location of the battery therein.

6. The holder of claim 5 wherein said cover has an extension therefrom, the extension having an aperture for accommodating a fastener therein, and the fastener securing with one of the upper and lower halves of the holder for securement of the cover in place after application of a battery with in the holder.

7. The holder of claim 2 wherein the housing has a wider shape at its forward end, and tapering to a narrower shape at its rearward end, so as to more conveniently accommodate the application of ones mouth to said rearward end of the housing to provide for entrance of compressed air into the housing for actuation of the integral whistle.

8. The holder of claim 1 wherein the two halves forming the upper and lower half of the holder includes ribbed walls externally and internally of their structure to provide for the intermating of said halves together, to form a tight closure for enclosing the whistle component and the light component for the keychain holder.
